(19) United States
(12) Patent Application Publication
(10) Pub. No.: US 2006/0122893 A1
(43) Pub. Date: Jun. 8, 2006

(54) Method and system for a lead generations system

(76) Inventor: Oded Gabbay, Dallas, TX (US)

Correspondence Address: WHITE-WELKER & WELKER, LLC, P.O. BOX 199, CLEAR SPRING, MD, 21722-0199, US

(21) Appl. No.: 11/003,573

(22) Filed: Dec. 4, 2004

(51) Int. Cl. G06Q 30/00

(52) U.S. Cl. 705/26

(57) ABSTRACT

The present invention represents a lead generations system, which incorporates a customer reward systems. In general the present invention provides a data processing system for uploading members request to target vendors based on products without displaying vendor information with interface of customer reward database. A product database comprising a plurality of vendors who supply products and a plurality of members who request the products as buyers. Members signup and request a product. Vendor list is not being displayed by the system. Member accounts are credited with reward and vendors receive notification. Due to non-vendors information disclosure all vendors have equal opportunity to compete.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to lead generations system. More specifically the present invention relates to a lead generations system, which incorporates a customer reward systems and provides a data processing system for uploading member requests to target vendors without displaying vendor information.

### BACKGROUND OF THE INVENTION

Lead generation systems, which are well known in the prior art, are based on the antiquated design of requiring a user to search for product or service providers manually on an individual basis or in groups. Samples of such lead generation systems are the yellow pages and search engines. These lead generation systems have substantial shortcomings in that their search processes only enable the user to reach a few or limited amount of providers.

Additionally, lead generation systems known in the prior art as previously mentioned provide no means for notifying or making aware providers of a search for a specific product or service. This lack of notification eliminates the ability of many businesses to compete for the sale who may be able to offer a better offer. In turn, the user or consumer is placed in a disadvantageous position as they are likely to be paying an inflated offer for the same product or service, which may have been provided by another company at a more competitive offer.

As known by the inventor, there are currently several websites on the Internet providing similar or related services as the present invention all of which do not address any of the shortcomings overcome by the present invention as discussed. For example, in the prior art, current websites offer similar or related services such as: systems which do not display suppliers and there is no reward system for users; systems which display suppliers and there is no reward system for users; systems which display suppliers, there is no reward system for users. and the public can view leads and price quotes without registering for the service.

The present invention improves on the prior art in that buyers/members do not need to look for suppliers and suppliers are not being displayed which give any supplier an equal ability to bid and quote to buyers. The present invention replaces any system that displays suppliers, or which causes a buyer to basically ignore suppliers, resulting in many qualified or better-qualified suppliers being put out of business.

This system of the present invention is provided with the ability to market to suppliers the name of buyers online automatically and provide suppliers a real advantage and an ability to reward buyers and give buyers better deals due to additional exposure. The system does not have to generate offers like other systems known in the prior art. The system of the present invention is a purely informational system and does not have to accept any active display of offers.

### SUMMARY OF THE INVENTION

In accordance with the present invention a method for a lead generations system is provided which overcomes the aforementioned problems of the prior art. The invention, in its preferred embodiment, consists of a lead generations system, which incorporates a customer reward systems. In general the present invention provides a data processing system for uploading members request to target vendors based on products without displaying vendor information with interface of customer reward database.

The website embodiment of the lead generations system of the present invention automatically reaches a large pool of suppliers and advises them about product or service requests while at the same time providing consumers with an award system for merely placing an inquiry. Unlike prior art systems, supplier information is not displayed to a user resulting in providing all registered suppliers an equal ability to compete regardless of company size.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the process of buyers and sellers registering for the system of the present invention;

FIG. 2 is a schematic that illustrates the interactions between buyers and sellers and the process of rewarding buyers for conducting searcher for products or services.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the method and system of the present invention. The invention is a lead generations system, which incorporates a customer reward systems. In general the present invention provides a data processing system for uploading members request to target vendors based on products without displaying vendor information with interface of customer reward database.

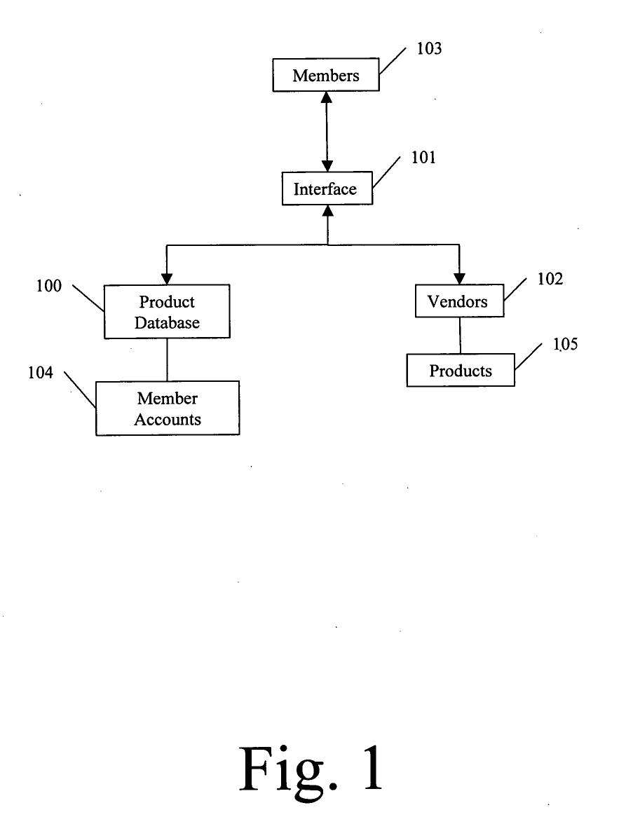

Now referring to FIG. 1, the present invention utilizes a product database (100) with an interface (101) for vendors (102) who supply products and members (103) who are buyers requesting the products or services offered by sellers. Members (103) sign-up and request a product while registered vendor's lists are not display by the system. Member accounts (104) are credited with rewards and vendors get notification. The result of the present invention is that due to non-vendors information disclosure all vendors (102) have equal opportunity to compete.

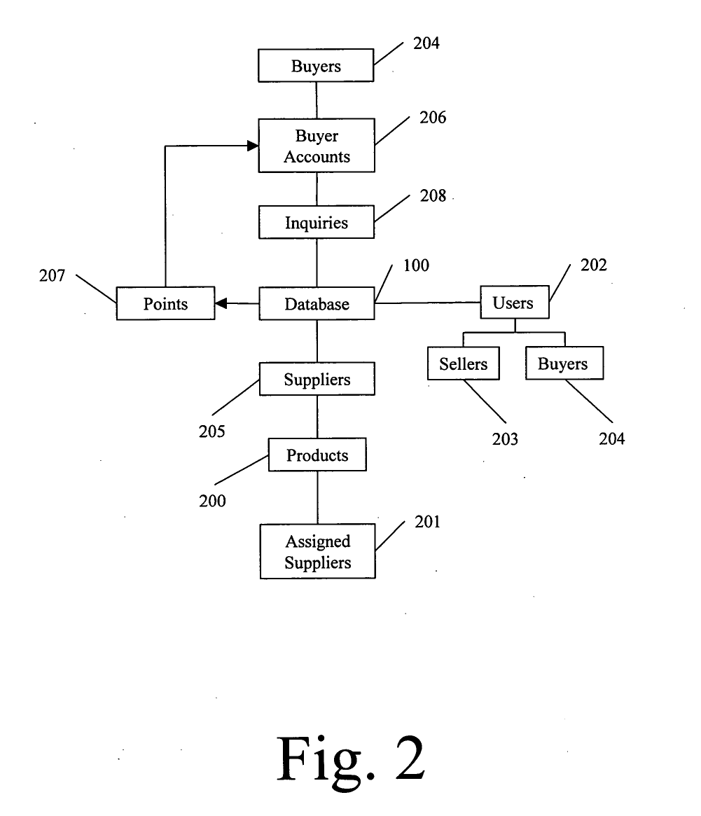

Now referring to FIG. 2, the database (100) of the present invention has products (200) with assigned suppliers (201). Users (202) are then registered and buyers (204) then request products or services from sellers (203). Buyers (204) are asked for products when applying and the system of the present invention will advise suppliers (205) of the product demand. Buyer's accounts (206) are credited with points (207) as a reward for product or service inquiries (208). Suppliers (205) will contact the buyers (204) based on the system of the present invention. Buyers (204) will review offers based on the system of the present invention and will chose a supplier (205). Once a supplier (205) is chosen, the system of the present invention will advise the supplier (205) of their selection and reward members.

All transactions can be done outside of the system or through the system at the option of the buyer (204) and supplier (205). Contract between buyer (204) and supplier (205) will be done outside the system. The system is a pure information system for suppliers (205) that incorporates a reward system for buyers (204).

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for enabling a lead generations system comprising:
registered buyers and sellers;
a database of products with suppliers assigned to each of said products;
buyers requesting products or services;
buyers are asked for product location when applicable;
system does not display product suppliers;
buyers are credited points in their accounts by the system as a reward for inquiring about a product or service;
system advising suppliers of products or services being requested;
supplier contact buyers directly using the system;
buyers will inspect offers outside of the system;
buyers will chose the desired suppliers.

2. The method for enabling a lead generations system of claim 1 wherein an immediate notification of product requests is sent to all vendors, giving all vendors the ability to compete for any requested product or service.

3. The method for enabling a lead generations system of claim 2 wherein buyers are provided rewards for their searches and receive a competitive market value as a result of more suppliers evaluating the product or service request.

4. The method for enabling a lead generations system of claims 1, 2, and 3 further comprising an optional search wherein buyers are provided with a display of seller information.

5. A system of network sites searching and transmitting product requests to vendors without displaying vendor information, with interface to sender database reward system.

6. The system of network sites of claim 5 further comprising:
a product database with a plurality of vendors who supply products and service;
buyers who request said products and services;
buyer accounts that are credited with rewards.
